(19) United States
(12) Patent Application Publication
(10) Pub. No.: US 2026/0173222 A1
(43) Pub. Date: Jun. 18, 2026

(54) EXTERNAL TEMPERATURE MEASUREMENT ACCESSORY CALIBRATION

(71) Applicant: WHIRLPOOL CORPORATION, BENTON HARBOR, MI (US)

(72) Inventors: Andrea Gallivanoni, Casorate Sempione (IT); Collin Andrew Stipe, St. Joseph, MI (US); Gian Mauro Musso, Portogruaro (IT); Mridula Unni, St. Joseph, MI (US)

(73) Assignee: WHIRLPOOL CORPORATION, BENTON HARBOR, MI (US)

(21) Appl. No.: 18/978,952

(22) Filed: Dec. 12, 2024

(51) Int. Cl. H05B 6/06; H05B 6/12

(52) U.S. Cl. CPC H05B 6/062; H05B 6/1209

(57) ABSTRACT

An external temperature measurement accessory for calibration of induction cooktops utilizes external temperature measurements of cookware taken during heating of the cookware to characterize thermal and/or electrical properties of cookware. A temperature behavior profile of the cookware is developed to provide temperature-based control of induction power of the induction cooktop.

### BACKGROUND OF THE DISCLOSURE

Various types of induction cooktops have been developed. Various approaches have been utilized to control power and temperature during cooking.

### SUMMARY OF THE DISCLOSURE

A cooking arrangement according to an aspect of the present disclosure includes an induction cooktop, a temperature measurement accessory having a temperature probe that is configured to contact an upwardly facing central cooking surface of a cooking vessel disposed on the induction cooktop, and an engagement surface that is configured to engage an upper edge of the cooking vessel while the temperature probe contacts the upwardly facing central cooking surface of the cooking vessel to support the temperature measurement accessory on the cooking vessel. The temperature measurement accessory may include a wireless interface that is configured to wirelessly transmit measured temperatures to a portable electronic device and/or to the induction cooktop. The induction cooktop is configured to control power to an induction unit based, at least in part, on a plurality of cookware parameters that predict a temperature of the cooking vessel in response to induction power levels. The cooking arrangement is configured to be operated in a calibration cycle while the temperature probe of the temperature measurement accessory engages (e.g. contacts) the upwardly facing central cooking surface of the cooking vessel whereby one or more cookware parameters for the cooking vessel can be determined. The cooking arrangement is configured to associate the cooking parameters with an identified cooking vessel and store the cooking parameters whereby the cooking parameters can be utilized during future use of the identified cooking vessel in connection with the induction cooktop.

A method of calibrating an induction cooktop according to another aspect of the present disclosure includes positioning a temperature probe of a temperature measurement accessory in contact with an upwardly facing cooking surface of a cooking vessel. The method includes recording temperature data from the temperature probe while providing power to the induction cooktop. The method further includes determining thermal and/or electrical parameters associated with the cooking vessel based, at least in part, on temperature and/or power data measured while the cooking vessel is heated by the induction cooktop. The temperature probe of the temperature measurement accessory is disengaged from the upwardly facing cooking surface of the cooking vessel. During cooking, a target temperature and the thermal and/or electrical system parameters associated with the cooking vessel may be utilized to control power of the induction cooktop while cooking food utilizing the cooking vessel.

A temperature measurement accessory according to another aspect of the present disclosure is configured to be used in connection with cooking vessels having an upwardly facing cooking surface and an upper edge that extends around the upwardly facing cooking surface. The temperature measurement accessory includes a temperature sensor disposed at a first end of the temperature measurement accessory and a handle disposed at a second end of the temperature measurement accessory opposite the first end. The temperature measurement accessory includes a retaining surface located between the first and second opposite ends of the temperature measurement accessory, wherein the retaining surface is transverse to an axis of the temperature measurement accessory. A center of gravity of the temperature measurement accessories is located between the first end of the temperature measurement accessory and the retaining surface whereby gravity biases the first end of the temperature measurement accessory downwardly into engagement (e.g. contact) with the upwardly facing cooking surface of a cooking vessel when the retaining surface engages an upper edge of a cooking vessel.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a partially schematic drawing of a cooking arrangement according to an aspect of the present disclosure;

FIG. 2 is a partially fragmentary isometric view of a cooking arrangement according to an aspect of the present disclosure;

FIG. 3 is a partially fragmentary cross-sectional view of the cooking arrangement of FIG. 2 taken along the line III-III; and

FIG. 4 is a graph showing temperature and estimated power during calibration of an induction cooktop.

The components in the figures are not necessarily to scale, emphasis instead being placed upon illustrating the principles described herein.

### DETAILED DESCRIPTION

The present illustrated embodiments reside primarily in a control and monitoring system of a cooking appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

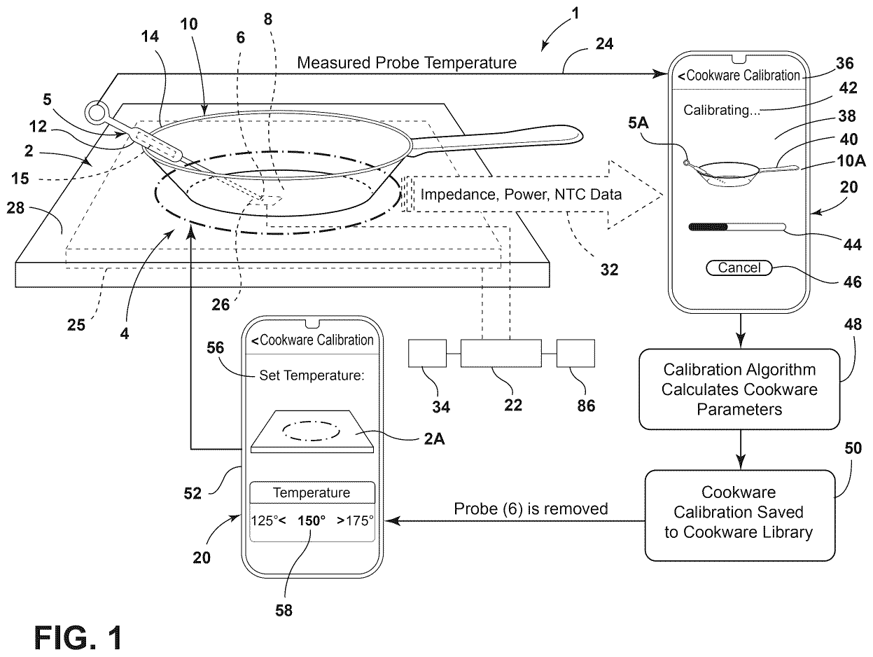

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer and/or user, and the term “rear” shall refer to the surface of the element further from the intended viewer and/or user. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Induction cooktops may control induction power utilizing inductive and/or thermal parameters that estimate a thermal response of cookware to inductive power. An example of which is United States Patent Publication Number 2023/0122477 to Gasparoni et al. filed on Oct. 19, 2021, the entire contents of which are incorporated by reference.

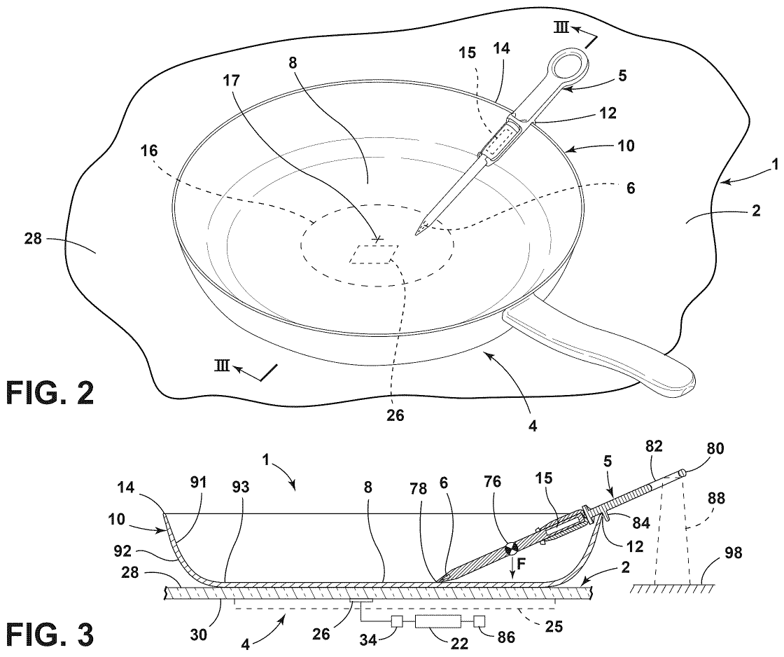

With reference to FIGS. 1-3, a cooking system or arrangement 1 according to an aspect of the present disclosure includes an induction cooktop 2 and a temperature measurement accessory 5. Induction cooktop 2 includes one or more cooking regions or zones 4 and associated induction units 25 which may be independently controlled. The temperature measurement accessory 5 includes a temperature probe 6 at a first end of the temperature measurement accessory 5 that is configured to engage (e.g. contact or abut) an upwardly facing cooking surface 8 of a cooking vessel 10 disposed on induction cooktop 2 to directly measure a temperature of surface 8. Probe 6 may contact a central region 16 (FIG. 2) of surface 8 that is within 25% of a center 17 of cooking vessel 10. The temperature measurement accessory 5 may optionally include an engagement surface 12 that is configured to engage an upper edge 14 of cooking vessel 10 while the temperature probe 6 contacts the cooking surface 8 of the cooking vessel 10 to support the temperature measurement accessory 5 on the cooking vessel 10. The temperature measurement accessory 5 may include a wireless interface 15 that is configured to wirelessly transmit measured temperatures to a portable electronic device 20 (FIG. 1) and/or to a controller 22 of the induction cooktop 2. Controller 22 may be configured to communicate wirelessly with portable electronic device 20. As discussed in more detail below, temperature measurement accessory 5 may have a center of gravity 76 (FIG. 3) that biases probe 6 of temperature measurement accessory 5 into contact with surface 8 and edge 14 of cooking vessel 10 due to gravitational force “F”.

Controller 22 of induction cooktop 2 is configured to control power to induction unit(s) 25 of cooktop 2 based, at least in part, on a plurality of cookware parameters that predict a temperature of the surface 8 of cooking vessel 10 in response to induction power levels of an induction unit 25 of a cooking zone 4. The cooking arrangement 1 is configured to be operated in a calibration cycle while the temperature probe 6 engages cooking surface 8 whereby the cookware (cooking) parameters for cooking vessel 10 can be determined. The cooking arrangement 1 may be configured to associate the cookware parameters with an identified cooking vessel 10 and store the cookware parameters, whereby the cookware parameters determined during a calibration cycle can be utilized during future use of induction cooktop 2. For example, a user may identify a specific cooking vessel 10 that was previously utilized in a calibration cycle, and the induction cooktop 2 may retrieve stored parameters for the specific cooking vessel 10 and use the retrieved parameters when a user is cooking food. A specific cooking vessel 10 may also be identified using an image recognition feature and camera of electronic device 20, sensors of induction cooktop 2, or other suitable means. The parameters and image data for one or more cooking vessels may optionally be stored in a database that is available to multiple users (e.g. via the internet) whereby a user can input a camera image of a cooking vessel 10, and a remote device and/or device 20 may search the stored images of the database to determine if cooking parameters for the cooking vessel are available. For example, device 20 may be configured to provide a preliminary identification (make, model, size, etc.) of a cooking vessel 10, and prompt a user to confirm that the preliminary identification is correct. If a user confirms the identification, induction cooktop 2 may utilize the cookware parameters from the database that are associated with the specific make, model, and size of the cooking vessel 10.

Referring again to FIGS. 1-3, induction cooktop 2 may comprise one or more temperature sensors 26 that measure one or more temperatures for each cooking region or zone 4. The sensor(s) 26 may comprise Negative Temperature Co-efficient (NTC) thermistors that are disposed adjacent (e.g. below) ceramic glass 28 of induction cooktop 2. In general, induction cooktop 2 may include a plurality of suitable temperature sensors that are configured to measure a temperature of ceramic glass 28 and/or ambient temperature. For example, sensor 26 may be configured to measure (estimate) a temperature of a lower surface 30 (FIG. 3) of ceramic glass 28. During a calibration cycle, a measured probe temperature (FIG. 1) from the temperature measurement accessory 5 may be communicated (e.g. wirelessly) to controller 22 and/or to a portable electronic device 20 via BLUETOOTH® or other suitable communication features. Controller 22 may also communicate (e.g. wirelessly) with portable electronic device 20. The controller 22 and/or portable electronic device 20 may be configured to record and/or determine (calculate) the impedance, power, and NTC (temperature) data 32 whereby controller 22 and/or portable electronic device 20 can control induction cooktop 2 during a calibration cycle. Induction cooktop 2 may include a Human Machine Interface (HMI) 34 that is operably connected to controller 22. HMI 34 may comprise audio inputs and outputs (microphones and speakers) a display screen, touch screen, or other suitable features. Thus, HMI 34 may be utilized in connection with a portable electronic device 20, or it may be used to provide the features of portable electronic device 20 described herein whereby the portable electronic device 20 may not be necessary.

Portable electronic device 20 and/or controller 22 (HMI 34) may be configured to provide a prompt 36 in the form of text or the like on a display 38. Portable electronic device 20 and/or HMI 34 may also be configured to provide instructions 40 which may include, for example, an image 5A of temperature measurement accessory 5, an image 10A of cooking vessel 10 and/or other displays or audio instructions. The portable electronic device 20 and/or HMI 34 may also be configured to provide text 42, a display 44, etc. informing a user of the progress of the calibration cycle. An input feature 46 can be utilized to cancel the calibration cycle.

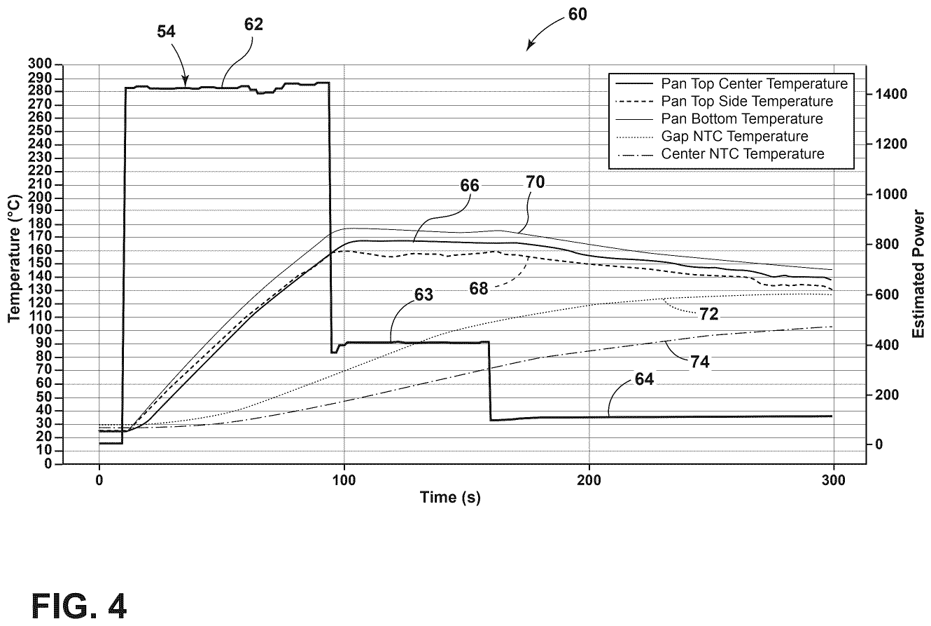

With further reference to FIG. 4, during a calibration cycle 60, power of the induction cooktop 2 (line 54) can be varied according to a predefined profile that includes one or more predefined power levels 62-64. The power levels 62-64 optionally comprise predefined power levels that are maintained for predefined periods of time. It will be understood, however, that the power levels 62-64 of FIG. 4 are merely examples of possible calibration power levels and times, and the present disclosure is not limited to specific power levels or times. Also, one or more calibration power levels may be zero. During the calibration cycle 60, the pan top center temperature (line 66) may be measured and recorded. In the illustrated example, the top center temperature 66 may comprise data from temperature probe 6 of temperature measurement accessory 5. A pan top side temperature 68 and a pan bottom temperature 70 may also be measured and recorded. The temperatures 68 and 70 are optional and may be measured utilizing additional temperature probes or the like. During calibration cycle 60, one or more temperature measurements (lines 72 and 74) may also be recorded from one or more sensors 26. The temperatures 72 and 74 may comprise temperature data received from a plurality of NTC temperature sensors 26 associated with a cooking zone 4 of induction cooktop 2. It will be understood that the NTC thermistors 26 that provide the temperatures 72 and 74 may optionally comprise known thermistors utilized in existing induction cooktops in a known configuration.

Referring again to FIG. 1, at step 48, a calibration algorithm calculates cookware parameters associated with cooking vessel 10. During the calibration cycle, the temperature probe 6 of temperature measurement accessory 5 may be placed in contact with a central portion of cooking surface 8 for a designated (predefined) length of time. Portable electronic device 20 and/or HMI 34 of induction cooktop 2 may provide guidance in the form of images, text, audio, etc. to a user during the calibration cycle. Once the temperature measurement accessory 5 is properly placed in contact with cooking surface 8 and the calibration setup is completed, a user does not (typically) need to engage with the induction cooktop 2 or temperature measurement accessory 5 during the calibration cycle.

The induction cooktop 2 (and/or device 20) utilizes the calibration cycle to elicit temperature responses (e.g. lines 72 and 74 of FIG. 4) from one or more temperature sensors 26 of induction cooktop 2 for a duration of time and continuously record the temperature profiles of the sensor(s) 26 and temperature probe 6 of temperature measurement accessory 5, preferably achieving a steady state for parameterization. The duration of the calibration cycle may vary. For example, calibration cycle may be one minute, two minutes, three minutes, four minutes, five minutes, or more. However, the calibration cycle may be less than one minute or greater than five minutes, and the present disclosure is not limited to any specific length of time. In general, the duration of the calibration cycle is sufficient to measure at least some temperatures utilizing sensor 6 and sensor(s) 26 in response to power levels as shown in the example of FIG. 4.

Using the measured temperature from temperature probe 6 of temperature measurement accessory 5, in addition to data relating to the load impedance, power, and one or more sensors 26 (e.g. positioned under ceramic glass 28), an algorithm analyzes the steady state temperature profiles (e.g. steady state and/or transient temperature profiles) and conducts system identification of thermal and electrical system parameters based on one or more of load impedance and measured temperatures. The algorithm determines a set of parameters based on how the measured accessory temperature profile changes with respect to a cooktop calibration cycle that varies the measured temperature profile(s) (e.g. lines 72 and/or 74 of FIG. 4). Temperature profile changes related to both the steady state and transient behavior of the sensor(s) 26 and temperatures measured by temperature sensor/probe 6 dictate how the cooking parameters are optimized.

Referring again to FIG. 1, after the cookware parameters are determined at step 48, the parameters associated with a cooking vessel 10 may optionally be saved to a cookware library. In general, numerous cooking vessels can be utilized in a plurality of calibration cycles, and the parameters for each cooking vessel can be stored in a cookware library whereby a user is not required to run a calibration cycle prior to each use of a cooking vessel, but rather can select a cooking vessel from the cookware library when cooking using induction cooktop 2. As discussed above, induction cooktop 2 and/or device 20 may optionally be configured to identify a cooking vessel (e.g. using image recognitions features or user input) and retrieve cookware parameters from a remote database that are associated with the cooking vessel.

Referring again to FIG. 1, after the cookware parameters are saved at step 50, the temperature probe 6 is removed from cooking vessel 10. It will be understood that the temperature probe 6 may be removed during or prior to steps 48 and 50 if temperature probe 6 and/or sensor(s) 26 have gathered sufficient temperature data to permit calculation of the cookware parameters for a given cooking vessel 10.

Following a calibration cycle, cooking may be initiated. For example, at step 52, portable electronic device 20 (and/or HMI 34) may display a prompt 56 and/or display one or more images such as a image 2A of an induction cooktop 2 to guide a user. The portable electronic device 20 may also prompt the user to enter a temperature 58 corresponding to a temperature of cooking surface 8 of a cooking vessel 10. The use of temperature measurement accessory 5 and temperature probe 6 to calibrate the system for use with a specific cooking vessel 10 allows the induction cooktop 2 to control power levels of induction cooktop 2 to provide a target temperature 58 that closely corresponds to an actual temperature of cooking surface 8 during cooking. Thus, calibration according to an aspect of the present disclosure permits cooking utilizing a user-selected target temperature 58 (optionally in connection with a user selected power level or range of power levels) rather than relying solely on a user-selected power level.

Referring again to FIG. 3, center of gravity 76 of temperature measurement accessory 5 biases temperature measurement accessory 5 into contact with cooking vessel 10 due to gravitational force F. Temperature probe 6 may be located at first end 78 of temperature measurement accessory 5, and temperature measurement accessory 5 may include a handle 82 at a second end 80 of temperature measurement accessory 5 that is opposite first end 78. Handle 82 may comprise a material having low heat transfer characteristics to reduce a rise in temperature of handle 82 during calibration cycles. The center of gravity 76 of temperature measurement accessory 5 is preferably between engagement surface 12 of temperature measurement accessory 5 and first end 78 of temperature measurement accessory 5 whereby first end 78 of temperature measurement accessory 5 is biased into contact with cooking surface 8 and engagement surface 12 of temperature measurement accessory 5 is biased into engagement with an upper edge 14 of cooking vessel 10 whereby temperature measurement accessory 5 is stable during calibration cycles. When temperature measurement accessory 5 is configured in this way, a user does not need to manually retain first end 78 of temperature measurement accessory 5 in contact with cooking surface 8 during the calibration process. Engagement surface 12 may be formed by a transverse protrusion 84 that extends transverse to a length of temperature measurement accessory 5. However, engagement surface 12 may be formed by virtually any suitable structure, and the present disclosure is not limited to the protrusion 84. Also, a clip or other retainer (not shown) may be utilized to retain temperature measurement accessory 5 in position during a calibration cycle if required for a particular application. Alternatively, a support such as stand 88 (FIG. 3) or the like may be utilized to support temperature measurement accessory 5 on an adjacent surface 98. Support 88, clip or other mechanical device may be utilized to support temperature measurement accessory 5 with first end 78 in contact with various surfaces of cooking vessel 10 including, for example, inner and/or outer side surfaces 91 and 92 and/or a region 93 of an inner pan surface that is outside of cooking surface 8.

As discussed above, one or more sensors such as NTC thermistors 26 may be utilized to provide temperature data concerning the cooking surface formed by ceramic glass 28. However, the present disclosure is not limited to a specific sensor configuration and alternative temperature sensors may be utilized. For example, infrared (IR) and/or far-infrared (FIR) sensors or other suitable sensors may also be utilized to determine the temperature of the cooking surface (e.g. ceramic glass 28). An optional ambient temperature sensor 86 (FIG. 1) may also be utilized to determine an ambient temperature in the vicinity of induction cooktop 2. It will be understood that the ambient temperature sensor 86 may comprise a component of induction cooktop 2, a portable electronic device 20, or other suitable arrangement.

Also, a calibration process according to the present disclosure may be automated whereby temperature measurement accessory 5 communicates directly with the controller 22 and/or HMI 34 of induction cooktop 2 to provide measured pan temperature data through a wired or wireless communication link and provide user guidance utilizing HMI 34 of induction cooktop 2. If configured in this way, use of portable electronic device 20 may not be required.

As noted above, the calibration parameters for a cooking vessel 10 may be stored and retrieved whereby the cooking parameters determined during a calibration cycle can be retrieved and reused, each time a cooking vessel 10 is used. Optionally, an additional (e.g. shorter) calibration cycle may be utilized during one or more future uses of a cooking vessel 10. Thus, a calibration cycle may be utilized each time a cooking vessel is used, and the calibration parameters do not necessarily need to be recorded for later use. If “new” calibration parameters are determined during calibration cycles prior to each use of a cooking vessel 10, the cooking parameters may be updated to account for aging or other changes in a cooking vessel 10. The calibration could be autonomous after setup and may require a user to be present and engaged (e.g. holding temperature measurement accessory 5 in-hand).

Also, a calibration cycle according to the present disclosure does not necessarily need to rely on pre-set power level cycling as discussed above in connection with FIG. 4. By using an external measurement device such as a temperature probe 6 of temperature measurement accessory 5, an alternative calibration cycle that utilizes a control algorithm and suitable control scheme such as Proportional Integral Derivative (PID) control, Optimal Control Methods, Internal Model Control, Model Predictive Control, etc. to vary power based on temperature setpoint feedback could be used to minimize error between the setpoint temperature and the estimated pan surface temperature/external measurement device. In general, the duration and power level of one or more voltage steps (levels) may be modified and/or have a shape other than a series of steps. For example, the power may ramp up to a selected (predefined) value over a selected (predefined) time period instead of an abrupt step. These changes can be dynamically decided depending on the actual thermal response of the system (i.e. based on the temperature measured by the temperature probe 6). For example, if a pan (cooking vessel) being used is much larger than usual, and made of heavier material, the thermal capacitance may be much larger than typical or expected. In this case, the temperature measured by the probe 6 may show a much shallower and slower increase, and the system may be configured to detect such a case, and decide to prolong the first step in such a way as to reach a plateau in the measured temperature. On the other hand, for a pan with a very small thermal capacitance, the system may be configured to detect a very quick initial rise in temperature and cut short the first step and/or decrease the power delivered in the first step in a pattern that can compensate for a quick rise in temperature and keep the temperature below a predefined maximum limit. The use of a suitable control scheme may, in some cases, ensure that the pan's surface steady state temperature is reached during the calibration cycle and may provide improved estimation data and cookware parameters (inductive and/or thermal).

A diagnostic cycle according to another aspect of the present disclosure may be utilized to identify key cookware characteristics including, but not limited to, cookware material, material distribution, size and shape that may be utilized to determine the thermodynamic model (cookware parameters). Based on the diagnostic cycle, an algorithm may be utilized to determine an optimum calibration cycle for a specific cookware configuration. If a diagnostic cycle is utilized, the information from the diagnostic cycle may be collected by having a user input the information manually. Alternatively, machine learning could be utilized to analyze an image (e.g. a digital photograph) and autonomously identify diagnostic cookware parameters when an application of portable electronic device 20 guides a user to take a digital photo of cookware for the cookware library.

In general, a calibration cycle may be conducted without any liquid or other material in cooking vessel 10. Alternatively, a liquid (e.g. oil or fat) or other material may be placed in cooking vessel 10 to simulate cooking conditions during a calibration cycle utilizing temperature measurement accessory 5. In general, positioning oil or other materials in cooking vessel 10 during a calibration cycle may, at least partially, simulate cooking conditions and improve the accuracy of temperature measurements of temperature probe 6, and may also permit more accurate determination of cookware parameters (e.g. by providing thermal mass that is similar to the thermal mass of food or other material that is typically present when cooking).

A cooking arrangement according to the present disclosure may provide precise and responsive cookware surface temperature measurements that allow for precise cooking temperature settings (target temperature settings) for a wide range of cooking vessels that may comprise various materials, sizes, thicknesses, etc. Knowledge of precise temperatures of cookware may assist in preventing overcooking and/or undercooking during the cooking process on induction cooktop 2. Correct/desirable cooking temperatures and inputs may also reduce energy consumption and reduce food waste.

The invention disclosed herein is further summarized in the following paragraphs and is further characterized by combinations of any and all of the various aspects described herein.

A cooking arrangement or system according to an aspect of the present disclosure includes an induction cooktop, a temperature measurement accessory having a temperature probe that is configured to contact an upwardly facing central cooking surface of a cooking vessel disposed on the induction cooktop, and an engagement surface that is configured to engage an upper edge of the cooking vessel while the temperature probe contacts the upwardly facing central cooking surface of the cooking vessel to support the temperature measurement accessory on the cooking vessel. The temperature measurement accessory may include a wireless interface that is configured to wirelessly transmit measured temperatures to a portable electronic device and/or to the induction cooktop. The induction cooktop is configured to control power to an induction unit based, at least in part, on a plurality of cookware parameters that predict a temperature of the cooking vessel in response to induction power levels. The cooking arrangement is configured to be operated in a calibration cycle while the temperature probe of the temperature measurement accessory engages (e.g. contacts) the upwardly facing central cooking surface of the cooking vessel whereby one or more cookware parameters for the cooking vessel can be determined. The cooking arrangement is configured to associate the cooking parameters with an identified cooking vessel and store the cooking parameters whereby the cooking parameters can be utilized during future use of the identified cooking vessel in connection with the induction cooktop.

The cooking parameters may optionally characterize the thermal and/or electrical properties of the identified cooking vessel.

The cooking arrangement may optionally be configured to store cookware parameters for a plurality of cooking vessels in a cookware library whereby a user can select a cooking vessel from the cookware library prior to cooking on the induction cooktop.

The induction cooktop is optionally configured to provide at least one predefined power level during the calibration cycle.

The predefined power level is optionally provided for a predefined length of time during the calibration cycle.

The induction cooktop is optionally configured to store a plurality of temperature responses of the temperature probe during the calibration cycle and utilize the temperature responses to determine the cooking parameters.

The induction cooktop optionally includes a ceramic glass layer and at least one temperature sensor adjacent (e.g. below) the ceramic glass layer that is configured to measure (estimate) a temperature of the ceramic glass layer. The induction cooktop or other component is optionally configured to record (store) temperature data from the temperature sensor during the calibration cycle and may be configured to utilize the temperature data from the temperature sensor to determine the cookware parameters.

The induction cooktop is optionally configured to utilize load impedance data collected during the calibration cycle to determine the cookware parameters.

The calibration cycle may optionally utilize a control algorithm and a Proportional Integral Derivative (PID) control to vary power based, at least in part, on temperature set point feedback to minimize error between the set point temperature and the temperature measured by the temperature probe of the temperature measurement accessory.

The cooking arrangement is optionally configured to utilize a diagnostic cycle to determine characteristics of a cooking vessel, wherein the characteristics may include a material of the cooking vessel and/or a size of the cooking vessel and/or a shape of the cooking vessel. The cooking arrangement is optionally configured to determine a length of time and/or a power level to be utilized during a calibration cycle based, at least in part, on the characteristics of the cooking vessel.

The temperature probe of the temperature measurement accessory is optionally disposed at a first end of the temperature measurement accessory. The temperature measurement accessory optionally includes a handle disposed at a second end of the temperature measurement accessory opposite the first end. The temperature measurement accessory optionally includes a retaining surface located between the first and second opposite ends of the temperature measurement accessory, wherein the retaining surface is optionally transverse to an axis of the temperature measurement accessory. A center of gravity of the temperature measurement accessories may be between the first end of the temperature measurement accessory and the retaining surface whereby gravity biases the first end of the temperature measurement accessory downwardly into engagement (e.g. contact) with the upwardly facing cooking surface of a cooking vessel when the retaining surface engages an upper edge of a cooking vessel extending around the upwardly facing cooking surface of the cooking vessel.

According to another aspect of the present disclosure, a method of calibrating an induction cooktop includes positioning a temperature probe of a temperature measurement accessory in contact with an upwardly facing cooking surface of a cooking vessel. The method includes recording temperature data from the temperature probe while providing power to the induction cooktop. The method further includes determining thermal and/or electrical parameters associated with the cooking vessel based, at least in part, on temperature and/or power data measured while the cooking vessel is heated by the induction cooktop. The temperature probe of the temperature measurement accessory is disengaged from the upwardly facing cooking surface of the cooking vessel. During cooking, a target temperature and the thermal and/or electrical system parameters associated with the cooking vessel may be utilized to control power of the induction cooktop while cooking food utilizing the cooking vessel.

The method optionally includes determining thermal and/or electrical parameters for a plurality of cooking vessels, storing the thermal and/or electrical parameters of the cooking vessels in a cookware library, retrieving selected thermal and/or electrical parameters from the cookware library for a specific cooking vessel, and utilizing a target temperature and the thermal and/or electrical parameters to control power of the induction cooktop during cooking.

The target temperature is optionally selected by a user.

The target temperature may optionally comprise an estimated temperature of the upwardly facing cooking surface of the cooking vessel. The estimated temperature may be determined, at least in part, utilizing the thermal and/or electrical parameters of the cooking vessel.

The method optionally includes wirelessly transmitting impedance and/or power and/or temperature data from the temperature measurement accessory to a controller of the induction cooktop and/or to a portable device during calibration. A controller of the induction cooktop and/or the portable device may be utilized to determine the thermal and/or electrical (e.g. inductive) parameters associated with the cooking vessel.

Power is optionally provided to the induction cooktop according to a predefined schedule that includes at least first and second power levels, wherein the first and second power levels are not equal.

The method optionally includes utilizing temperature data from a temperature sensor disposed below a glass ceramic surface of the induction cooktop to determine the thermal and/or electrical parameters of the cooking vessel.

A temperature measurement accessory according to another aspect of the present disclosure is configured to be used in connection with cooking vessels having an upwardly facing cooking surface and an upper edge that extends around the upwardly facing cooking surface. The temperature measurement accessory includes a temperature sensor disposed at a first end of the temperature measurement accessory and a handle disposed at a second end of the temperature measurement accessory opposite the first end. The temperature measurement accessory includes a retaining surface located between the first and second opposite ends of the temperature measurement accessory, wherein the retaining surface is transverse to an axis of the temperature measurement accessory. A center of gravity of the temperature measurement accessories is located between the first end of the temperature measurement accessory and the retaining surface whereby gravity biases the first end of the temperature measurement accessory downwardly into engagement (e.g. contact) with the upwardly facing cooking surface of a cooking vessel when the retaining surface engages an upper edge of a cooking vessel.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooking arrangement, comprising:
an induction cooktop configured to control power to an induction unit based, at least in part, on a plurality of cookware parameters that predict a temperature of a cooking vessel on the induction cooktop in response to induction power levels;
a temperature measurement accessory having a temperature probe that is configured to engage an upwardly facing central cooking surface of a cooking vessel disposed on the induction cooktop, and an engagement surface that is configured to engage an upper edge of the cooking vessel while the temperature probe engages the upwardly-facing central cooking surface of the cooking vessel to support the temperature measurement accessory on the cooking vessel, the temperature measurement accessory including a wireless interface that is configured to wirelessly transmit measured temperatures to a portable electronic device and/or to the induction cooktop;
and wherein the cooking arrangement is configured to be operated in a calibration cycle while the temperature probe of the temperature measurement accessory engages the upwardly facing central cooking surface of the cooking vessel whereby cookware parameters of the cooking vessel can be determined;
and wherein the cooking arrangement is configured to associate the cookware parameters with an identified cooking vessel and store the cookware parameters whereby the cookware parameters can be utilized during future cooking with the identified cooking vessel on the induction cooktop.

2. The cooking arrangement of claim 1, wherein:
the cookware parameters characterize thermal and/or electrical properties of the cooking vessel.

3. The cooking arrangement of claim 2, wherein:
the cooking arrangement is configured to store cookware parameters associated with a plurality of cooking vessels in a cookware library whereby a user can select a cooking vessel and cookware parameters from the cookware library prior to cooking on the induction cooktop.

4. The cooking arrangement of claim 1, wherein:
the induction cooktop is configured to provide at least one predefined power level during the calibration cycle.

5. The cooking arrangement of claim 4, wherein:
the predefined power level is provided for a predefined length of time during the calibration cycle.

6. The cooking arrangement of claim 5, wherein:
the induction cooktop is configured to store a plurality of temperature responses of the temperature probe during the calibration cycle and utilize the temperature responses to determine the cookware parameters.

7. The cooking arrangement of claim 6, wherein:
the induction cooktop includes a ceramic glass layer and at least one temperature sensor below the ceramic glass layer, wherein the temperature sensor is configured to measure a temperature of the ceramic glass layer; and
the induction cooktop is configured to record temperature data from the temperature sensor during the calibration cycle, and to utilize the temperature data from the temperature sensor to determine the cookware parameters.

8. The cooking arrangement of claim 7, wherein:
the induction cooktop is configured to utilize load impedance data collected during the calibration cycle to determine the cookware parameters.

9. The cooking arrangement of claim 1, wherein:
the calibration cycle varies power during the calibration cycle based, at least in part, on temperature set point feedback to minimize error between the set point temperature and the temperature measured by the temperature probe of the temperature measurement accessory.

10. The cooking arrangement of claim 1, wherein:
the cooking arrangement is configured to utilize a diagnostic cycle to determine characteristics of a cooking vessel, wherein the characteristics include a material of the cooking vessel and/or a size of the cooking vessel and/or a shape of the cooking vessel; and
the cooking arrangement is configured to determine a time and/or power to be utilized during a calibration cycle based, at least in part, on the characteristics of the cooking vessel.

11. The cooking arrangement of claim 1, wherein:
the temperature probe of the temperature measurement accessory is disposed at a first end of the temperature measurement accessory;
the temperature measurement accessory includes a handle disposed at a second end of the temperature measurement accessory opposite the first end;
the temperature measurement accessory includes a retaining surface located between the first and second opposite ends of the temperature measurement accessory, wherein the retaining surface is transverse to an axis of the temperature measurement accessory, and a center of gravity of the temperature measurement accessories is located between the first end of the temperature measurement accessory and the retaining surface whereby gravity biases the first end of the temperature measurement accessory downwardly into engagement with the upwardly facing central cooking surface of a cooking vessel when the retaining surface engages an upper edge of a cooking vessel extending around the upwardly-facing central cooking surface of the cooking vessel.

12. A method of calibrating an induction cooktop, the method comprising:
positioning a temperature measurement accessory such that a temperature probe of the temperature measurement accessory operably engages an upwardly facing cooking surface of a cooking vessel;
recording temperature data from the temperature probe while providing power to the induction cooktop;
determining thermal and electrical parameters associated with the cooking vessel based, at least in part, on temperature and power data measured while the cooking vessel is heated by the induction cooktop;
disengaging the temperature probe of the temperature measurement accessory from the upwardly facing cooking surface of the cooking vessel; and
utilizing a target temperature and the thermal and electrical system parameters associated with the cooking vessel to control power of the induction cooktop while cooking food utilizing the cooking vessel.

13. The method of claim 12, including:
determining thermal and electrical parameters for a plurality of cooking vessels;
storing the thermal and electrical parameters of the cooking vessels in a cookware library;
retrieving selected thermal and electrical parameters from the cookware library for a specific cooking vessel; and
utilizing a target temperature and the thermal and electrical parameters to control power of the induction cooktop.

14. The method of claim 13, wherein:
the target temperature is selected by a user.

15. The method of claim 14, wherein:
the target temperature comprises an estimated temperature of the upwardly facing cooking surface of the cooking vessel; and
the estimated temperature is determined, at least in part, utilizing the thermal and electrical parameters of the cooking vessel.

16. The method of claim 12, including:
utilizing the controller of the induction cooktop and/or the portable device to determine the thermal and electrical parameters associated with the cooking vessel.

17. The method of claim 12, wherein:
the temperature probe of the temperature measurement accessory is disposed at a first end of the temperature measurement accessory; and including:
positioning a retaining surface of the temperature measurement accessory in engagement with an upper edge of the cooking vessel with a center of gravity of the temperature measurement accessory between the first end of the temperature measurement accessory and the retaining surface whereby gravity causes the first end of the temperature measurement accessory to remain in contact with the upwardly facing surface of the cooking vessel.

18. The method of claim 12, wherein:
power is provided to the induction cooktop according to a predefined schedule that includes at least first and second power levels, wherein the first and second power levels are not equal.

19. The method of claim 12, including:
utilizing temperature data from a temperature sensor disposed below a glass ceramic surface of the induction cooktop to determine the thermal and electrical parameters of the cooking vessel.

20. A temperature measurement accessory configured to be used in connection with cooking vessels having an upwardly facing cooking surface and an upper edge that extends around the upwardly facing cooking surface, the temperature measurement accessory comprising:
a temperature sensor disposed at a first end of the temperature measurement accessory;
a handle disposed at a second end of the temperature measurement accessory opposite the first end; and:
wherein the temperature measurement accessory includes a retaining surface located between the first and second opposite ends of the temperature measurement accessory, wherein the retaining surface is transverse to an axis of the temperature measurement accessory, and a center of gravity of the temperature measurement accessories is located between the first end of the temperature measurement accessory and the retaining surface whereby gravity biases the first end of the temperature measurement accessory downwardly into engagement with an upwardly facing cooking surface of a cooking vessel when the retaining surface engages an upper edge of a cooking vessel.
